(19) United States
(12) Patent Application Publication
(10) Pub. No.: US 2025/0079914 A1
(43) Pub. Date: Mar. 6, 2025

(54) REDUCTION OF COOLING GAS INDUCED RADIAL FORCES AND RECIRCULATION FLOWS IN ELECTRIC MOTOR OF INTEGRATED COMPRESSOR

(71) Applicant: Solar Turbines Incorporated, San Diego, CA (US)

(72) Inventors: Sahand PIROUZPANAH, San Diego, CA (US); Michael B. MCCUNE, Escondido, CA (US); Lei ZHU, San Diego, CA (US); Jess Lee FREEMAN, Poway, CA (US); Tianli ZHANG, San Diego, CA (US)

(73) Assignee: Solar Turbines Incorporated, San Diego, CA (US)

(21) Appl. No.: 18/242,436

(22) Filed: Sep. 5, 2023

(51) Int. Cl. H02K 1/20

(52) U.S. Cl. CPC H02K 1/20; H02K 2201/03

(57) ABSTRACT

An integrated compressor comprises an electric motor that is prone to windage losses, radial loads, and recirculation flows. According to a first feature, partial grooves or riblets may be formed on the surface of a motor stator that defines the radially outward boundary of the air gap between the motor stator and the motor rotor. These partial grooves or riblets may maintain low to moderate windage losses, while reducing radial loads in the motor. According to a second feature, a support structure may be designed with a nose portion that is configured to disrupt or otherwise reduce recirculation flows within the end-winding cavity housing the end-winding of the motor. According to a third feature, the spiral orientation of the top coil of the end-winding may be aligned with the rotation direction of the motor rotor to reduce recirculation flows within the end-winding cavity.

### TECHNICAL FIELD

The embodiments described herein are generally directed to integrated compressors, and, more particularly, to the reduction of radial forces and recirculation flows in an electric motor of an integrated compressor.

### BACKGROUND

Integrated compressors are hermetically sealed systems in which a compressor is coupled to an electric motor. During operation of an integrated compressor, the electric motor is subjected to high pressures and/or dense cooling gases. Maintaining the temperatures of the motor, including its windings and rotor, below their critical temperatures is important to the health, lifetime, efficiency, and operating envelope of the electric motor. The temperatures of these critical components are determined by the geometry of the electric motor, the solid material properties, electromagnetic losses, windage losses, the temperature of the cooling gas, and the like.

The present disclosure is directed toward overcoming one or more of the problems discovered by the inventors.

### SUMMARY

In an embodiment, a system (e.g., motor) comprises: a rotor (e.g., motor rotor) with a longitudinal axis; a stator (e.g., motor stator) encircling the rotor and concentric with the longitudinal axis; and an air gap between the stator and the rotor, wherein a radially inward-facing surface of the stator, defining a radially outward boundary of the air gap, comprises a plurality of partial grooves that are recessed into the radially inward-facing surface or a plurality of riblets that protrude from the radially inward-facing surface.

In an embodiment, a motor comprises: a motor rotor with a longitudinal axis; a motor stator encircling the motor rotor and concentric with the longitudinal axis; an air gap between the motor stator and the motor rotor; at least one end-winding extending from an end of the motor stator into an end-winding cavity; and a support structure that partially defines the end-winding cavity, wherein the support structure includes a main body with a radially outward end and a radially inward end, and a nose portion extending from the radially inward end and configured to disrupt a recirculation flow within the end-winding cavity, wherein the nose portion comprises a plurality of ribs that are each oriented along an axial axis that is parallel to the longitudinal axis, and wherein the plurality of ribs of the nose portion are spaced apart from each other around the longitudinal axis by a circumferential distance, wherein a radially inward-facing surface of the motor stator, defining a radially outward boundary of the air gap, comprises a plurality of riblets that protrude from the radially inward-facing surface, wherein the plurality of riblets are arranged as a plurality of ribs that are each aligned with the axial axis of a respective one of the plurality of ribs of the nose portion.

In an embodiment, a motor comprises: a motor rotor with a longitudinal axis; a motor stator encircling the motor rotor and concentric with the longitudinal axis; an air gap between the motor stator and the motor rotor; and at least one end-winding extending from an end of the motor stator into an end-winding cavity, wherein a spiral orientation of a top coil of the at least one end-winding is aligned with a rotation direction of the motor rotor.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 is a cross-sectional schematic diagram of an integrated compressor, according to an embodiment;

FIG. 2 is a cross-sectional schematic diagram of a portion of a motor of an integrated compressor, according to an embodiment;

FIGS. 3-5 are perspective views of portions of a radially inward-facing surface of a motor stator, according to alternative embodiments;

FIGS. 6-9 are perspective views of at least a portion of a support structure, according to alternative embodiments;

FIG. 10 is a perspective view of portions of a radially inward-facing surface of a motor stator and a support structure, according to an embodiment; and

FIG. 11 is a perspective view of a portion of a motor in an integrated compressor, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

For clarity and ease of explanation, some surfaces and details may be omitted in the present description and figures. In addition, references herein to “forward” and “aft” are used to describe the relative positions of components, as depicted in the drawings, and do not imply any absolute orientation of components or their relationship to a flow of fluid, such as gas. Also, it should be understood that, as used herein, the terms “side,” “top,” “bottom,” “front,” “rear,” “above,” “below,” and the like are used for convenience to convey the relative positions of various components with respect to each other, and do not imply any specific orientation of those components in absolute terms (e.g., with respect to the external environment or the ground). In addition, the terms “respective” and “respectively” signify an association between members of a group of first components and members of a group of second components. For example, the phrase “each component A connected to a respective component B” would signify A1 connected to B1, A2 connected to B2, . . . and AN connected to BN.

It should also be understood that the various components illustrated herein are not necessarily drawn to scale. In other words, the features disclosed in various embodiments may be implemented using different relative dimensions within and between components than those illustrated in the drawings.

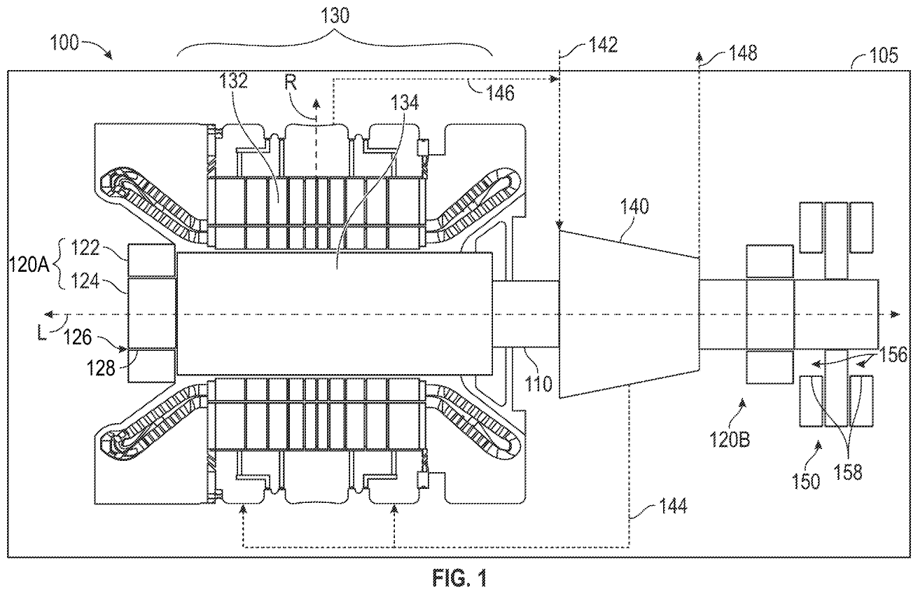

FIG. 1 is a cross-sectional schematic diagram of an integrated compressor 100, according to an embodiment. Integrated comprises 100 comprises a compressor housing 105 enclosing a shaft 110 with a central longitudinal axis L. Shaft 110 may comprise a plurality of joined components. A number of other components of integrated compressor 100 are concentric with longitudinal axis L and may be annular around longitudinal axis L. A radial axis may refer to any axis or direction that radiates outward from longitudinal axis L at a substantially orthogonal angle to longitudinal axis L, such as radial axis R in FIG. 1. Thus, the term “radially outward” should be understood to mean farther from or away from longitudinal axis L, whereas the term “radially inward” should be understood to mean closer or towards longitudinal axis L. As used herein, the term “radial” will refer to any axis or direction that is substantially perpendicular to longitudinal axis L, and the term “axial” will refer to any axis or direction that is substantially parallel to longitudinal axis L.

In an embodiment, integrated compressor 100 comprises a first radial bearing system 120A, a motor 130, a compression system 140, a second radial bearing system 120B, and a thrust bearing system 150. First radial bearing system 120A and second radial bearing system 120B (collectively referred to herein as radial bearing systems 120) may comprise a radial magnetic bearing (RMB) positioned annularly around longitudinal axis L. For example, each radial bearing system 120 may comprise an RMB stator 122 that is concentric with an RMB rotor 124 around longitudinal axis L. RMB rotor 124 may form or be fixed around a component of shaft 110. RMB stator 122 utilizes a magnetic suspension force to suspend RMB rotor 124 without contacting RMB stator 122, so as to form an air gap 126 between RMB stator 122 and RMB rotor 124. Thus, shaft 110, including RMB rotor 124, may rotate freely within RMB stator 122 without physically contacting stationary components, such as RMB stator 122. Notably, RMB stator 122 has a radially inward-facing surface 128. Similarly, thrust bearing system 150 may comprise a thrust magnetic bearing (TMB) that is positioned annularly around and axially along longitudinal axis L. The thrust magnetic bearing may also comprise a stator and a rotor that is suspended by a magnetic force generated between the stator and the rotor, but is designed to take axial thrust loads during operation of integrated compressor 100. Notably, the TMB stator will also have a radially inward-facing surface 158 facing an air gap 156 between the stator and rotor.

Motor 130 comprises a motor stator 132 and a motor rotor 134. Motor stator 132 may comprise one or a plurality of electromagnetic coils in the form of windings that may be connected to a power source. As energy flows through the electromagnetic coil(s), a magnetic field is created that drives the rotation of motor rotor 134 around longitudinal axis L. Motor rotor 134 may form or be fixed around a component of shaft 110, such that, when motor stator 132 is powered, motor rotor 134, and thereby shaft 110, are driven to rotate within the housing of integrated compressor 100.

Compression system 140 may comprise one or more stages of rotor assemblies. An inlet path 142 feeds the working fluid (e.g., the primary gas, such as air, methane, etc.) into the first stage of compression system 140. Inlet path 142 may comprise a radial channel through the housing of integrated compressor 100 to provide fluid communication between an exterior of integrated compressor 100 and the first stage of compression system 140. Thus, inlet path 142 may be connected to a pipeline (e.g., via the fastening of corresponding flanges) or another source of the working fluid. The working fluid is compressed through each stage of compression system 140. It should be understood that each stage in compression system 140 may comprise one or more airfoils that are fixed to and extend radially from shaft 110 and rotate with shaft 110. Once the working fluid has been compressed through the final stage of compression system 140, the working fluid may be discharged through an outlet path 148. Outlet path 148 may comprise a radial channel through the housing of integrated compressor 100. Outlet path 148 may be connected to a pipeline (e.g., via the fastening of corresponding flanges) or another destination of the compressed working fluid.

A bleed path 144 may fluidly connect compression system 140 to a cooling system of motor 130, to provide working fluid from compression system 140 to a coolant inlet of motor 130. In other words, relatively cool working fluid is extracted after one or more stages of compression system 140 and supplied as coolant to motor 130 via bleed path 144. Similarly, a reintroduction path 146 may fluidly connect the cooling system of motor 130 to inlet path 142, to reintroduce working fluid from a coolant outlet of motor 130 to compression system 140. In other words, coolant, which has extracted heat from motor 130, is extracted from motor 130 and supplied as working fluid to the first stage of compression system 140.

It should be understood that the illustrated integrated compressor 100 is simply one example of an integrated compressor. Thus, while integrated compressor 100 is illustrated with a beam-style design, integrated compressor 100 could utilize any different type of design, including an overhung-style design (e.g., with the inlet and outlet of compression system 140 on opposite sides of motor 130). The arrangements of bearing systems 120 and 150 may differ depending on the chosen design. In addition, it should be understood that various types of motor 130 may be used in integrated compressor 100, including a motor 130 with any number of poles and/or phases.

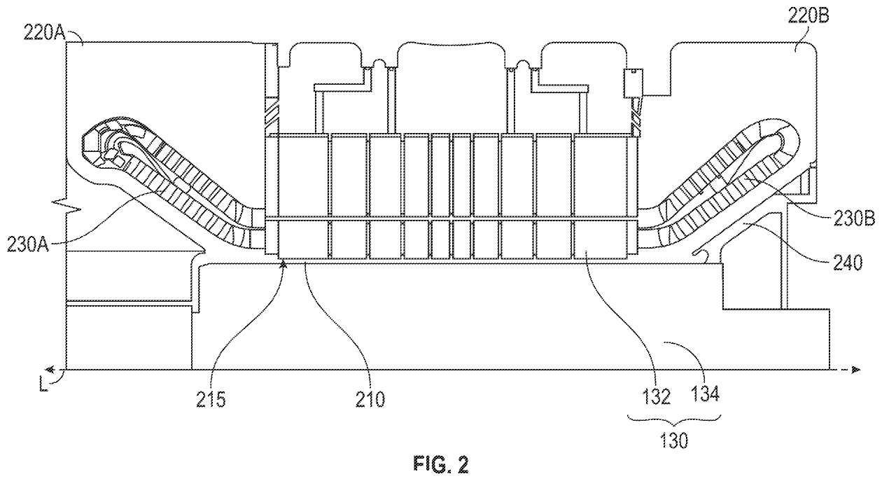

FIG. 2 is a cross-sectional schematic diagram of a portion of motor 130 of integrated compressor 100, according to an embodiment. An air gap 210 exists between motor stator 132 and motor rotor 134. Notably, the outer diameter of air gap 210 is defined by a radially inward-facing surface 215 of motor stator 132. In other words, radially inward-facing surface 215 defines the radially outward boundary of air gap 210. In addition, there are end-winding cavities 220A and 220B on either side of motor stator 132 to accommodate end-windings 230A and 230B, respectively. Each winding of motor stator 132 may comprise an in-slot region within a slot in motor stator 132 and end-winding 230 outside the slot. Each end-winding 230 extends from the slot within a respective end of motor stator 132, and, together with conductors within the slot, conducts electricity to generate the magnetic field that drives rotation of motor rotor 134. An aft, radially inward portion of aft end-winding cavity 220B may comprise a support structure 240. Alternatively or additionally, the forward, radially inward portion of forward end-winding cavity 220A could comprise a support structure that is the same as or different from support structure 240.

It should be understood that, as used herein, the letter may be dropped from a reference numeral whenever a reference to an element can be applied equally to all components sharing the numeric portion of that reference numeral. For example, a reference to end-winding cavity 220 may apply to forward end-winding cavity 220A and/or aft end-winding cavity 220B. Similarly, a reference to end-winding 230 may apply equally to end-windings 230A and 230B.

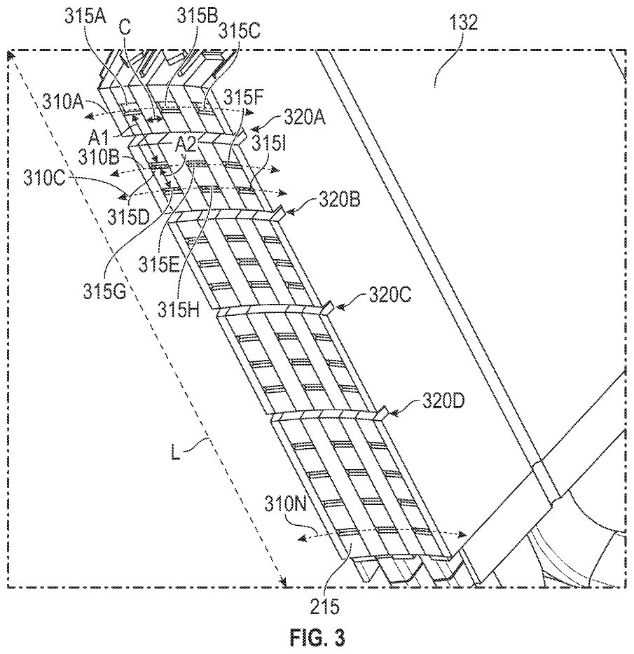

FIG. 3 is a perspective view of a portion of radially inward-facing surface 215 of motor stator 132, according to a first embodiment. It should be understood that, in reality, radially inward-facing surface 215 would form an annular or cylindrical surface around longitudinal axis L. In this first embodiment, surface 215 comprises a plurality of partial grooves 315. Each partial groove 315 comprises a recess formed radially outward into radially inward-facing surface 215. As illustrated, each partial groove 315 may be rectangular (e.g., 2×15 millimeters) with a uniform depth. Alternatively, one or more, including potentially all, of partial grooves 315 may be formed in a non-rectangular shape (e.g., elliptical, triangular, etc.) and/or have a non-uniform depth.

Partial grooves 315 may be arranged in circumferential rings 310 around longitudinal axis L, such as circumferential rings 310A, 310B, 310C, and 310N. Conceptually, each circumferential ring 310 may be thought of as a groove, around the circumference of radially inward-facing surface 215, concentric with longitudinal axis L, that is broken up into a plurality of partial grooves 315. Circumferential rings 310 may be spaced apart by a plurality of axial intervals along longitudinal axis L, with the partial grooves 315 within a given circumferential ring 310 spaced apart by a plurality of circumferential intervals around longitudinal axis L. In other words, partial grooves 315 may be arranged at circumferential and axial intervals within radially inward-facing surface 215. For example, partial groove 315A is arranged at a circumferential distance C from partial groove 315B, which is arranged at a circumferential distance C from partial groove 315C. It should be understood that partial grooves 315 may be arranged around the entire circumference of radially inward-facing surface 215 at intervals of the same circumferential distance (i.e., equidistant intervals) or two or more different circumferential distances (e.g., a pattern with two or more sets of intervals). In addition, partial groove 315A is arranged at an axial distance A1 from partial groove 315D, which is arranged at an axial distance A2 from partial groove 315G. It should be understood that partial grooves 315 may be arranged along a plurality of axial axes through radially inward-facing surface 215 at intervals of the same axial distance (e.g., equidistant intervals) or two or more different axial distances (e.g., a pattern with two or more sets of intervals).

In an alternative embodiment, partial grooves 315 may be offset from adjacent partial grooves 315 in the axial and/or circumferential directions. For example, partial groove 315B may be offset from adjacent partial grooves 315A and/or 315C in the circumferential direction, such that partial groove 315B is not centered within the same circumferential ring 310A as partial groove 315A and/or 315C. As an alternative or additional example, partial groove 315D may be offset from adjacent partial grooves 315A and/or 315G in the axial direction, such that partial groove 315D is not centered on the same axial axis as partial groove 315A and/or 315G.

In an embodiment, all circumferential intervals are equal (e.g., all equal to circumferential distance C), while the axial intervals may differ between different pairs of adjacent circumferential rings 310 (e.g., A1 does not equal A2). In particular, as illustrated, circumferential rings 310 may be divided into subsets of one or a plurality of circumferential rings 310, with each circumferential ring 310 in a given subset separated by an equidistant axial interval, but with adjacent subsets separated by a different axial interval than the axial interval within the subsets. For example, partial grooves 315A, 315B, and 315C are a portion of a first circumferential ring 310A representing a first subset consisting of a single circumferential ring. Partial grooves 315D, 315E, and 315F are a portion of a second circumferential ring 310B, and partial grooves 315G, 315H, and 315I are a portion of a third circumferential ring 310C, which are both within a second subset consisting of two circumferential rings. The axial distance A1 between the first subset and the second subset may be different (e.g., greater) than the axial distance A2 between partial grooves 315 within a subset. For example, the axial distance A1 between partial groove 315A in the first subset and partial groove 315D in the second subset is greater than the axial distance A2 between partial grooves 315D and 315G within the second subset.

These subsets of circumferential rings 310 may be defined and separated, along an axial axis through radially inward-facing surface 215, by circumferential grooves 320. For example circumferential groove 320A separates the first subset, comprising circumferential ring 310A, from the second subset, comprising circumferential rings 310B and 310C. Similarly, circumferential grooves 320B, 320C, and 320D separate other adjacent subsets of circumferential rings 310, comprising partial grooves 315. Circumferential grooves 320 may be full, continuous grooves around the entire circumference of radially inward-facing surface 215. Cooling holes may be formed in circumferential grooves 320 to allow cooling gas (e.g., compressed working fluid that is bled from compression system 140 via bleed path 144) to flow radially inward to or outward away from air gap 210. In an alternative embodiment, circumferential grooves 320 and/or the cooling holes may be omitted.

In an embodiment, partial grooves 315 may have different dimensions across two or more subsets of circumferential rings 310. For example, partial grooves 315A, 315B, and 315C in the first subset that includes circumferential ring 310A have an axial length that is longer than the axial length of partial grooves 315D, 315E, 315F, 315G, 315H, and 315I in the second subset that includes circumferential rings 310B and 310C. More generally, partial grooves 315 on one or both axial ends of radially inward-facing surface 215 may have a greater axial length than partial grooves 315 in the center of radially inward-facing surface 215. Alternatively or additionally, the dimensions of partial grooves 315 may differ across subsets in other respects, such as shape, circumferential length, radial depth, and/or the like. For example, the dimensions of partial grooves 315 on one or both axial ends of radially inward-facing surface 215 may differ from the dimensions of partial grooves 315 in the axial center of radially inward-facing surface 215. In an alternative embodiment, all partial grooves 315 may have the same dimensions.

In the illustrated embodiment, partial grooves 315 are aligned around the circumference of radially inward-facing surface 215, to form a plurality of circumferential rings 310. In this case, all partial grooves 315 within a single circumferential ring 310 may have the same dimensions, while partial grooves 315 in different circumferential rings 310 may have the same or different dimensions. Alternatively, partial grooves 315 may be aligned along axial axes through radially inward-facing surface 215. In this case, all partial grooves 315 along a single axial axis may have the same dimensions, while partial grooves 315 along different axial axes may have different dimensions. As another alternative, partial grooves 315 may be aligned both around the circumference of radially inward-facing surface 215 and along axial axes through radially inward-facing surface 215. In this case, all partial grooves 315 within radially inward-facing surface 215 may have the same dimensions.

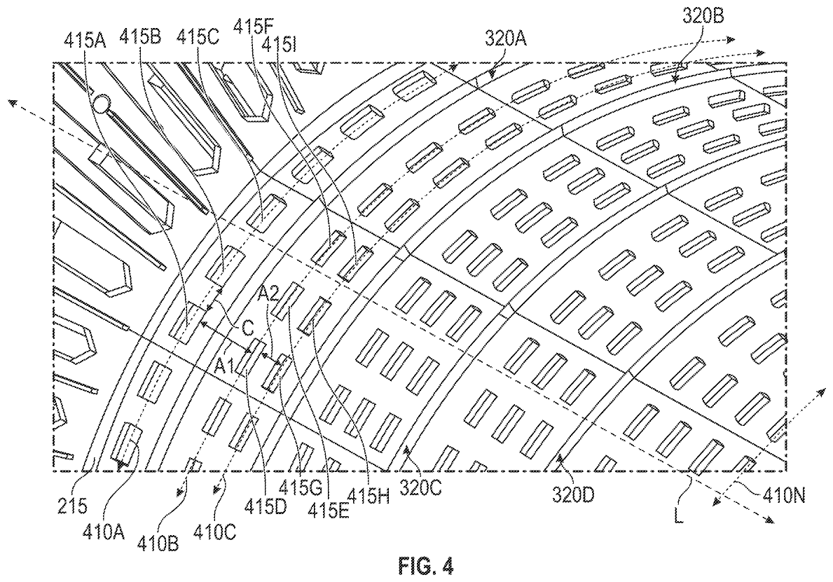

FIG. 4 is a perspective view of a portion of radially inward-facing surface 215 of motor stator 132, according to a second embodiment. It should be understood that, in reality, radially inward-facing surface 215 would form an annular or cylindrical surface around longitudinal axis L. In this second embodiment, surface 215 comprises a plurality of riblets 415. Each riblet 415 comprises a protrusion extending radially inward from radially inward-facing surface 215. As illustrated, each riblet 415 may be rectangular (e.g., 3×15 millimeters) with a uniform thickness. Alternatively, one or more, including potentially all, of riblets 415 may be formed in a non-rectangular shape (e.g., elliptical, triangular, etc.) and/or have a non-uniform thickness.

Riblets 415 may be arranged in circumferential rings 410 around longitudinal axis L, such as circumferential rings 410A, 410B, 410C, and 410N. Conceptually, each circumferential ring 410 may be thought of as a rib, around the circumference of radially inward-facing surface 215, concentric or eccentric with longitudinal axis L, depending on the flexibility of shaft 110, that is broken up into a plurality of riblets 415. Circumferential rings 410 may be spaced apart by a plurality of axial intervals along longitudinal axis L, with the riblets 415 within a given circumferential ring 410 spaced apart by a plurality of circumferential intervals around longitudinal axis L. In other words, riblets 415 may be arranged at circumferential and axial intervals on radially inward-facing surface 215. For example, riblet 415A is arranged at a circumferential distance C from riblet 415B, which is arranged at a circumferential distance from riblet 415C. It should be understood that riblets 415 may be arranged around the entire circumference of radially inward-facing surface 215 at intervals of the same circumferential distance (i.e., equidistant intervals) or two or more different circumferential distances (e.g., a pattern with two or more sets of intervals). In addition, riblet 415A is arranged at an axial distance A1 from riblet 415D, which is arranged at an axial distance A2 from riblet 415G. It should be understood that riblets 415 may be arranged along a plurality of axial axes through radially inward-facing surface 215 at intervals of the same axial distance (e.g., equidistant intervals) or two or more different axial distances (e.g., a pattern with two or more sets of intervals).

In an alternative embodiment, riblets 415 may be offset from adjacent riblets 415 in the axial and/or circumferential directions. For example, riblet 415B may be offset from adjacent riblets 415A and/or 415C in the circumferential direction, such that riblet 415B is not centered within the same circumferential ring 410A as riblet 415A and/or 415C. As an alternative or additional example, riblet 415D may be offset from adjacent riblets 415A and/or 415G in the axial direction, such that riblet 415D is not centered on the same axial axis as riblet 415A and/or 415G.

In an embodiment, all circumferential intervals are equal (e.g., all equal to circumferential distance C), while the axial intervals may differ between different pairs of adjacent circumferential rings 410 (e.g., A1 does not equal A2). In particular, as illustrated, circumferential rings 410 may be divided into subsets of one or a plurality of circumferential rings 410, with each circumferential ring 410 in a given subset separated by an equidistant axial interval, but with adjacent subsets separated by a different axial interval than the axial interval within the subsets. For example, riblets 415A, 415B, and 415C are a portion of a first circumferential ring 410A representing a first subset consisting of a single circumferential ring. Riblets 415D, 415E, and 415F are a portion of a second circumferential ring 410B, and riblets 415G, 415H, and 415I are a portion of a third circumferential ring 410C, which are both within a second subset consisting of two circumferential rings. The axial distance A1 between the first subset and the second subset may be different (e.g., greater) than the axial distance A2 between riblets 415 within a subset. For example, the axial distance A1 between riblet 415A in the first subset and riblet 415D in the second subset is greater than the axial distance A2 between riblets 415D and 415G within the second subset.

These subsets of circumferential rings 410 may be defined and separated, along an axial axis through radially inward-facing surface 215, by circumferential grooves 320. For example circumferential groove 320A separates the first subset, comprising circumferential ring 410A, from the second subset, comprising circumferential rings 410B and 410C. Similarly, circumferential grooves 320B, 320C, and 320D separate other adjacent subsets of circumferential rings 410, comprising riblets 415. Circumferential grooves 320 may be full, continuous grooves around the entire circumference of radially inward-facing surface 215 or may be partial grooves (e.g., with different circumferential lengths and/or intervals than riblets 415). Cooling holes may be formed in circumferential grooves 320 to allow cooling gas (e.g., compressed working fluid that is bled from compression system 140 via bleed path 144) to flow radially inward to or outward away from air gap 210. In an alternative embodiment, circumferential grooves 320 and/or the cooling holes may be omitted.

In an embodiment, riblets 415 may have different dimensions across two or more subsets of circumferential rings 410. For example, riblets 415A, 415B, and 415C in the first subset that includes circumferential ring 410A have an axial length that is longer than the axial length of riblets 415D, 415E, 415F, 415G, 415H, and 415I in the second subset that includes circumferential rings 410B and 410C. More generally, riblets 415 on one or both axial ends of radially inward-facing surface 215 may have a greater axial length than riblets 415 in the center of radially inward-facing surface 215. Alternatively or additionally, the dimensions of riblets 415 may differ across subsets in other respects, such as shape, circumferential length, radial thickness, and/or the like. For example, the dimensions of riblets 415 on one or both axial ends of radially inward-facing surface 215 may differ from the dimensions of riblets 415 in the axial center of radially inward-facing surface 215. In an alternative embodiment, all riblets 415 may have the same dimensions.

In an embodiment, riblets 415 may radially taper, in radial thickness, along the axial axis. For example, riblet 415A may extend further radially inward on a second axial end (e.g., the aft end) than on the first axial end (e.g., the forward end), with a gradual transition (e.g., linear or curved transition) in radial thickness between the two axial ends. Riblets 415D may be tapered in the same manner from the first axial end to the second axial end, with the first axial end starting from a radial thickness that corresponds to an imaginary extension of the gradual transition from the second axial end of riblet 415A (i.e., across the gap between the adjacent riblets 415A and 415D) and continuing that gradual transition to the second axial end of riblet 415D. Each riblet 415 along each axial axis may be tapered in this manner, such that the entire axial rib is tapered along the axial axis. The taper may have the low end at the forward end or the aft end of radially inward-facing surface 215, with the high end at the opposite end of radially inward-facing surface 215. It should be understood that the maximum radial thickness of the tapered rib will not exceed the radial thickness of air gap 210.

In the illustrated embodiment, riblets 415 are aligned around the circumference of radially inward-facing surface 215, to form a plurality of circumferential rings 410. In this case, all riblets 415 within a single circumferential ring 410 may have the same dimensions, while riblets 415 in different circumferential rings 410 may have the same or different dimensions. Alternatively, riblets 415 may be aligned along axial axes through radially inward-facing surface 215. In this case, all riblets 415 along a single axial axis may have the same dimensions, while riblets 415 along different axial axes may have different dimensions. As another alternative, riblets 415 may be aligned both around the circumference of radially inward-facing surface 215 and along axial axes through radially inward-facing surface 215. In this case, all riblets 415 on radially inward-facing surface 215 may have the same dimensions.

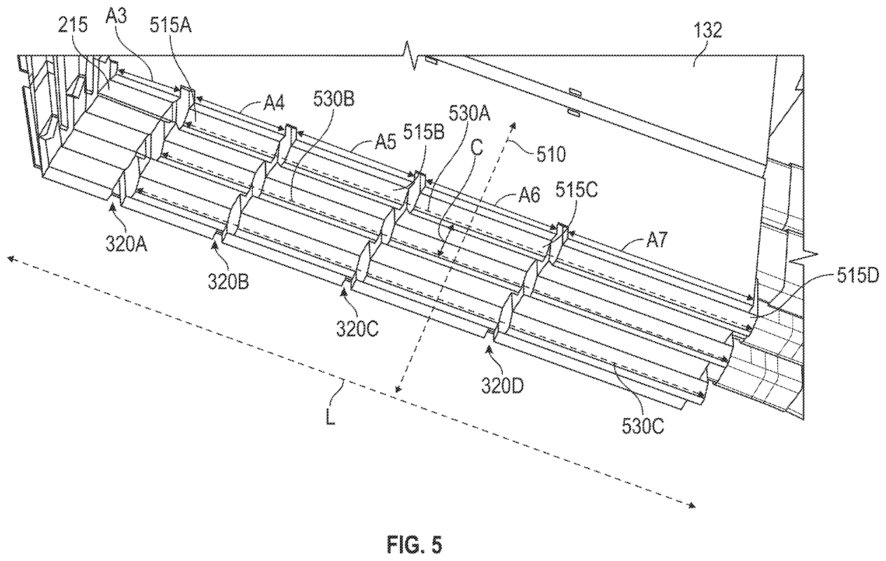

FIG. 5 is a perspective view of a portion of radially inward-facing surface 215 of motor stator 132, according to a third embodiment. It should be understood that, in reality, radially inward-facing surface 215 would form an annular or cylindrical surface around longitudinal axis L. In this third embodiment, surface 215 comprises a plurality of axial riblets 515. Each riblet 515 comprises a protrusion extending radially inward from radially inward-facing surface 215. Unlike riblets 415 which are oriented circumferentially, with the shorter dimension parallel to longitudinal axis L and the longer dimension generally perpendicular to longitudinal axis L, riblets 515 are oriented axially with the shorter dimension generally perpendicular to longitudinal axis L and the longer dimension parallel to longitudinal axis L.

FIG. 5 only illustrates half of motor stator 132 on one end (e.g., aft end) of motor stator 132. The complete radially inward-facing surface 215 would comprise a mirrored half (i.e., mirrored across a plane that is perpendicular to longitudinal axis L) on the opposing end (e.g., forward end) of motor stator 132. Thus, it should be understood that any description herein of the illustrated half of radially inward-facing surface 215 may apply equally to the mirrored half of radially inward-facing surface 215 that is not illustrated.

Each riblet 515 may have a trapezoidal shape, in a cross-sectional plane that is perpendicular to longitudinal axis L. Alternatively, each riblet 515 may have a different cross-sectional shape and/or two or more riblets 515 may have different cross-sectional shapes than each other. Similarly, the dimensions of the cross-sectional shape may be the same for all riblets 515, or the dimensions of the cross-sectional shape for two or more riblets 515 may differ from each other.

Each riblet 515 may extend the entire axial length between adjacent circumferential grooves 320 or between a circumferential groove 320 and one end of motor stator 132. For example, riblet 515A extends from circumferential groove 320A to circumferential groove 320B, riblet 515B extends from circumferential groove 320B to circumferential groove 320C, riblet 515C extends from circumferential groove 320C to circumferential groove 320D, and riblet 515D extends from circumferential groove 320D to an aft end of motor stator 132. In the illustrated embodiment, there are no riblets 515 between the center of motor stator 132 and circumferential groove 320A. In an alternative embodiment, there may be riblets 515 between the center of motor stator 132 and circumferential groove 320A. In an embodiment, there may be a circumferential groove 320 in the center of radially inward-facing surface 215, between the two halves of radially inward-facing surface 215. It should be understood that circumferential grooves 320 may be the same as described with respect to the other embodiments, and therefore, any description of circumferential grooves 320 with respect to other embodiments applies equally to this third embodiment.

Notably, riblets 515 are aligned in the axial direction, such that, conceptually, they would form continuous axial ribs 530, along an axial axis, from a forward point on radially inward-facing surface 215 to the aft end of radially inward-facing surface 215, except for the fact that each rib 530 is intersected by one or more circumferential grooves 320. Thus, for example, riblets 515A, 515B, 515C, and 515D could collectively be considered a single rib 530A, that is intersected by circumferential grooves 320B, 320C, and 320D. Similarly, ribs 530B and 530C are formed along additional axial axes. It should be understood that the number of riblets 515 in each rib 530 will generally be dictated by the number of circumferential grooves 320 that are used. Thus, while each rib 530 is illustrated as being composed of four riblets 515 in one end of motor stator 132, each rib 530 could instead consist of one, two, three, or five or more riblets 515.

The axial length of each riblet 515 in a rib 530 will generally be dictated by the spacing between adjacent circumferential grooves 320. In the illustrated embodiment, there is an axial distance A3 between the center of motor stator 132 (which may comprise a circumferential groove 320) and circumferential groove 320A, an axial distance A4 between circumferential groove 320A and circumferential groove 320B, an axial distance A5 between circumferential groove 320B and circumferential groove 320C, an axial distance A6 between circumferential groove 320C and circumferential groove 320D, and an axial distance A7 between circumferential groove 320D and the aft end of motor stator 132. The axial length of riblet 515A may be equal to or less than axial distance A4, the axial length of riblet 515B may be equal to or less than axial distance A5, and the axial length of riblet 515C may be equal to or less than axial distance A6. However, the axial length of riblet 515D at the aft-most position may be slightly longer than axial distance A7, so as to axially extend slightly from the aft end of motor stator 132. Notably, in the illustrated embodiment, there is no riblet 515 between the center of motor stator 132 and circumferential groove 320A. In fact, there may be a recess between the center of motor stator 132 and circumferential groove 320A. In an alternative embodiment, there may be a riblet 515 between the center of motor stator 132 and circumferential groove 320A. In this case, the axial length of the riblet 515 may be equal to axial length A3.

The axial distances between circumferential grooves 320 and/or between a circumferential groove 320 and an end of motor stator 132 may increase in the center-to-aft direction (i.e., A3<A4<A5<A6<A7), such that the length of each corresponding riblet 515 in a rib 530 also increases from the center to the aft end. In an alternative embodiment, all of the axial distances between circumferential grooves 320 may be identical, the axial distances between circumferential grooves 320 may decrease in the center-to-aft direction, or the axial distances between circumferential grooves 320 may have some other pattern or no pattern at all. In an alternative embodiment, circumferential grooves 320 may be omitted, such that axial sets of riblets 515 become singular continuous ribs 530.

Ribs 530, composed of axially aligned riblets 515, may be spaced apart, along a circumferential axis 510, by a plurality of circumferential intervals around longitudinal axis L. In other words, each riblet 515 may be arranged at circumferential distance C from each adjacent riblet 515 along circumferential axis 510. It is generally contemplated that circumferential distances C would be equal along the entire circumferential axis 510, such that ribs 530 are equidistantly spaced around longitudinal axis L. However, in an alternative embodiment, the circumferential distance C between one or more rib 530, along circumferential axis 510, could differ. In summary, a plurality of riblets 515 are arranged as a plurality of ribs 530 (e.g., intersected by a plurality of circumferential grooves 320) that are each oriented along an axial axis that is parallel to longitudinal axis L, and the plurality of riblets 515 are spaced apart from each other around longitudinal axis L by a circumferential distance C.

In an embodiment, ribs 530 may radially taper, in radial thickness, along the axial axis. For example, each rib 530 may extend further radially inward on a second axial end (e.g., the aft end) than on the first axial end (e.g., the forward end), with a gradual transition (e.g., linear or curved transition) in radial thickness between the two axial ends. It should be understood that the maximum radial thickness of each rib 530 will not exceed the radial thickness of air gap 210.

In an embodiment, radially inward-facing surface 215 of motor stator 132 may have alternating slot and teeth regions around longitudinal axis L, with the teeth regions extending more radially inward than the slot regions. Partial grooves 315, riblets 415, and/or ribs 530 may be formed on one or both of the slot regions and the teeth regions. However, partial grooves 315 and riblets 415 may be more suitable for the slot regions, whereas ribs 530 may be suitable for both the slot regions and the teeth regions. In an embodiment, the slot regions may comprise one of the described features (e.g., partial grooves 315, riblets 415, or ribs 530), whereas the teeth regions may comprise a different one of the described features.

As illustrated in FIG. 2, support structure 240 defines a radially inward and aft portion of aft end-winding cavity 220B. While support structure 240 is illustrated as defining a portion of aft end-winding cavity 220B, a similar or identical support structure may be used to define a radially inward and forward portion of forward end-winding cavity 220A (i.e., in a reverse axial orientation). Accordingly, disclosed embodiments of support structure 240 or features of the disclosed embodiments of support structure 240 may be applied to one or both of end-winding cavities 220A and 230B. Notably, the design of support structure 240 affects the recirculation of fluid (e.g., the working fluid, such as methane gas) within end-winding cavity 220. The disclosed embodiments of support structure 240 are designed to reduce the recirculation of fluid within end-winding cavity 220 by disrupting the recirculation flow within end-winding cavity 220. Notably, with reference to the orientation of aft end-winding cavity 220B that is illustrated in FIG. 2, the recirculation flow tends to form in a generally counterclockwise direction from air gap 210, axially outward and radially upward along support structure 240, and axially inward towards end-winding 230B.

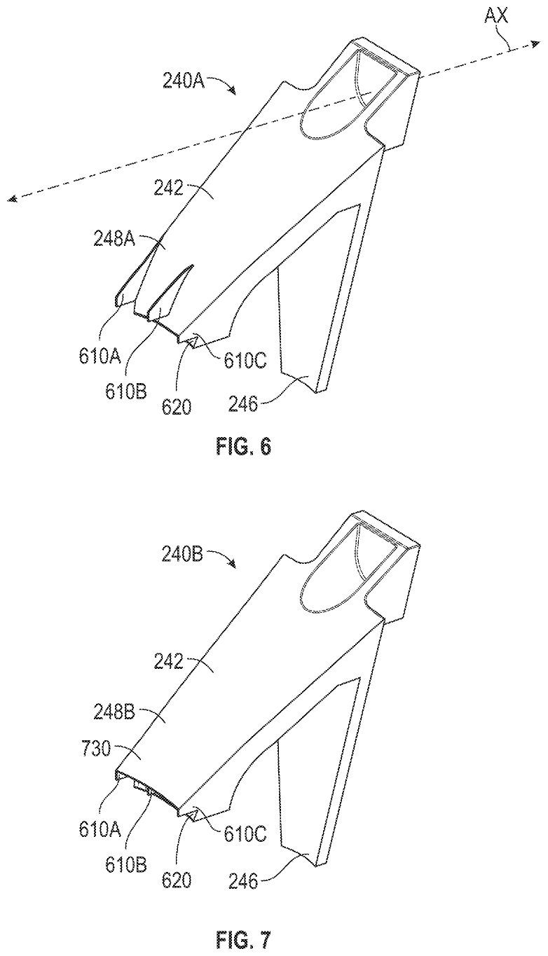

FIG. 6 is a perspective view of at least a portion of support structure 240, according to a first embodiment, referred to herein as support structure 240A. It should be understood that an overall support structure 240 may comprise a plurality of support structures 240A, joined into an annulus around longitudinal axis L, and/or may be formed by replicating or extending support structure 240A along a circle around longitudinal axis L to form a full annulus or to form one or more segments (e.g., quadrants) that may be joined into an annulus around longitudinal axis L. In any case, it should be understood that support structure 240A only represents a segment of the overall support structure 240 in integrated compressor 100.

As illustrated, support structure 240A comprises a main body 242. A radially outward-facing surface of main body 242 is exposed to end-winding cavity 220 and is angled with respect to an axial axis AX to define a sloped surface within end-winding cavity 220. As a result, a first end of main body 242 is radially outward from a second end of main body 242. Support structure 240A may also comprise a leg 246, extending radially inward from the radially outward first end of main body 242. Leg 246 may separate a cavity into a forward side and aft side with a small clearance to the radially inward rotating component. Leg 246 may function to increase the pressure on the aft side, relative to a support structure without leg 246. On the radially inward second end of main body 242, support structure 240A may comprise a nose portion 248A.

Nose portion 248A comprises a plurality of vanes 610 extending radially outward from a radially outward-facing surface of nose portion 248A. Each of the plurality of vanes 610A, 610B, and 610C are equidistantly spaced. It should be understood that, in reality, support structure 240A is annular, with vanes 610 spaced at equidistant intervals around the entire circumference of support structure 240A. Each vane 610 may act to interrupt circumferential fluid flow within end-winding cavity 220 along the radially outward-facing surface of support structure 240A, to thereby disrupt or otherwise influence the recirculation of fluid within end-winding cavity 220.

Nose portion 248A may also comprise a lip 620 radially inward from vane(s) 610. The radially outward-facing surface of nose portion 248 may curve radially inward from the second end of main body 242 into lip 620, according to any suitable radius of curvature. In contrast, vane(s) 610 may continue to substantially follow the slope of main body 242. This creates a flow path through vane(s) 610 between lip 620 and main body 242 to interrupt the recirculation flow of fluid within end-winding cavity 220.

FIG. 7 is a perspective view of at least a portion of support structure 240, according to a second embodiment, referred to herein as support structure 240B. Support structure 240B may be identical to support structure 240A, except that nose portion 248B differs from nose portion 248A. Thus, it should be understood that the descriptions of main body 242 and leg 246 with respect to support structure 240A, as well as general descriptions of support structure 240A, apply equally to support structure 240B, and therefore, will not be redundantly included herein.

Nose portion 248B may be identical to nose portion 248A, except that a shroud 730 covers vanes 610. In effect, shroud 730 may extend the radially outward-facing surface of main body 242 over vanes 610. As a result, pockets may be formed between adjacent vanes 610. In particular, each pocket is defined by adjacent vanes 610, nose portions 248A, and shroud 730, and is open towards lip 620 so as to be in fluid communication with end-winding cavity 220 in the vicinity of lip 620. For example, a first pocket is formed between vanes 610A and 610B, and a second pocket is formed between vanes 610B and 610C. These pockets may act to interrupt fluid flow within end-winding cavity 220. In particular, fluid flowing axially and radially outward along the radially outward-facing surface of support structure 240B may be caught in the pockets and forced back in the reverse direction to thereby disrupt the recirculation flow of fluid within end-winding cavity 220.

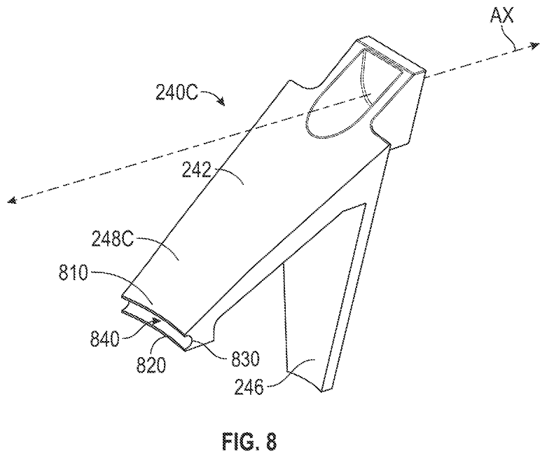

FIG. 8 is a perspective view of at least a portion of support structure 240, according to a third embodiment, referred to herein as support structure 240C. Support structure 240C may be identical to support structure 240A, except that nose portion 248C differs from nose portion 248A. Thus, it should be understood that the descriptions of main body 242 and leg 246 with respect to support structure 240A, as well as general descriptions of support structure 240A, apply equally to support structure 240C, and therefore, will not be redundantly included herein.

Nose portion 248C comprises a radially outward lip 810 and a radially inward lip 820 that are connected by a curved surface 830 to form a mouth 840. Radially outward lip 810 may be sloped (i.e., angled with respect to axial axis AX) at substantially the same angle as main body 242. Radially inward lip 820 may be substantially parallel with axial axis AX or may be formed at an angle with respect to axial axis AX. Curved surface 830 may be formed according to any suitable radius of curvature. Similarly to the pockets in nose portion 248B, mouth 840 may act to interrupt fluid flow within end-winding cavity 220. In particular, fluid flowing axially and radially outward along the radially outward-facing surface of support structure 240C may be caught in mouth 840 and turned back in the reverse direction by curved surface 830 to thereby disrupt the recirculation flow of fluid within end-winding cavity 220.

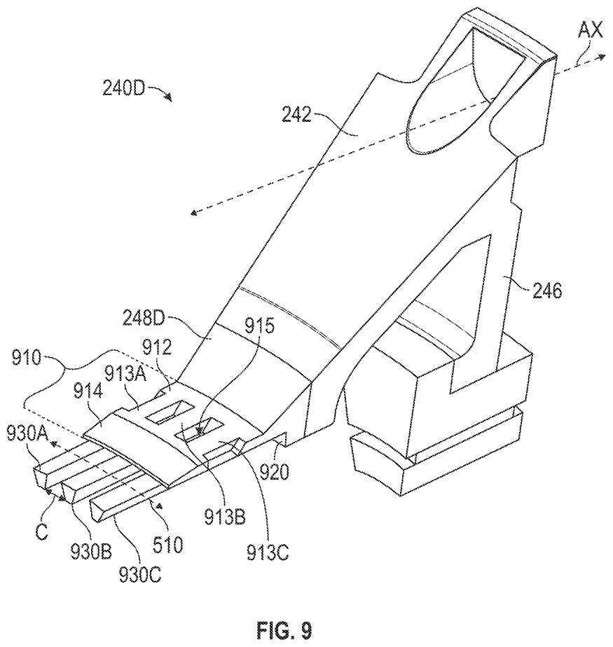

FIG. 9 is a perspective view of at least a portion of support structure 240, according to a fourth embodiment, referred to herein as support structure 240D. Support structure 240D may be identical to support structure 240A, except that nose portion 248D differs from nose portion 248A. Thus, it should be understood that the descriptions of main body 242 and leg 246 with respect to support structure 240A, as well as general descriptions of support structure 240A, apply equally to support structure 240D, and therefore, will not be redundantly included herein.

Nose portion 248D extends, at substantially the same angle as main body 242, to a lattice structure 910. Lattice structure 910 may extend forward from main body 242, for example, in an axial direction, parallel to axial axis AX. Lattice structure 910 may comprise two parallel rails 912 and 914, that are annular around longitudinal axis L. A plurality of rungs 913 extend between rails 912 and 914 (e.g., axially), such that spaces 915 are formed between adjacent pairs of rungs 913. Each space 915 extends radially through lattice structure 910, and is defined by rails 912 and 914 and a pair of adjacent rungs 913. As illustrated, spaces 915 may be rectangular shaped. However, spaces 915 may have other shapes, including ovals, triangles, or the like, as dictated by the shapes of rail 912, rail 914, and/or rungs 913. In addition, spaces 915 may all have the same dimensions and/or shapes, or may have different dimensions and/or shapes than each other.

The radial thickness of rail 914, which is further forward than rail 912 and forms the end of lattice structure 910, may decrease in the forward direction, such that the forward end of rail 914 has a sloped surface (i.e., angled with respect to axial axis AX). The slope of rail 914 is illustrated as having a smaller slope (i.e., smaller angle with respect to axial axis AX) than main body 242. However, in an alternative embodiment, the slope of rail 914 could be the same as or greater than slope of main body 242.

Nose portion 248D may also comprise a radially inward lip 920, radially inward from the aft end of lattice structure 910. In addition, nose portion 248D may comprise a plurality of ribs 930, illustrated as ribs 930A, 930B, and 930C, extending, for example, axially from lip 920 in a forward direction, parallel to axial axis AX. In an alternative embodiment, ribs 930 could be angled in a circumferential direction around longitudinal axis L. Ribs 930 may be spaced apart, along a circumferential axis 510 (i.e., around longitudinal axis L), by a circumferential distance C, which may be the same circumferential distance C, by which ribs 530 are spaced apart, in an embodiment which combines support structure 240D with the third embodiment of radially inward-facing surface 215, illustrated in FIG. 5.

The plurality of ribs 930 may be positioned radially inward from lattice structure 910. Each rib 930 may be longer than lattice structure 910 in an axial direction, such that each rib 930 extends forward beyond the end of rail 914. Along circumferential axis 510, each rib 930 may be aligned with a rung 913 in lattice structure 910, such that each space 915 is positioned radially outward from the space between a pair of adjacent ribs 930. In other words, there is a radial channel that extends through each pair of adjacent ribs 930 and a respective pair of adjacent rungs 913. These channels, along with lattice structure 910, lip 920, and ribs 930 may act to interrupt fluid flow within end-winding cavity 220. In particular, fluid flowing axially and radially outward along the radially outward-facing surface of support structure 240D may be caught in these structures and channels to thereby disrupt the recirculation flow of fluid within end-winding cavity 220.

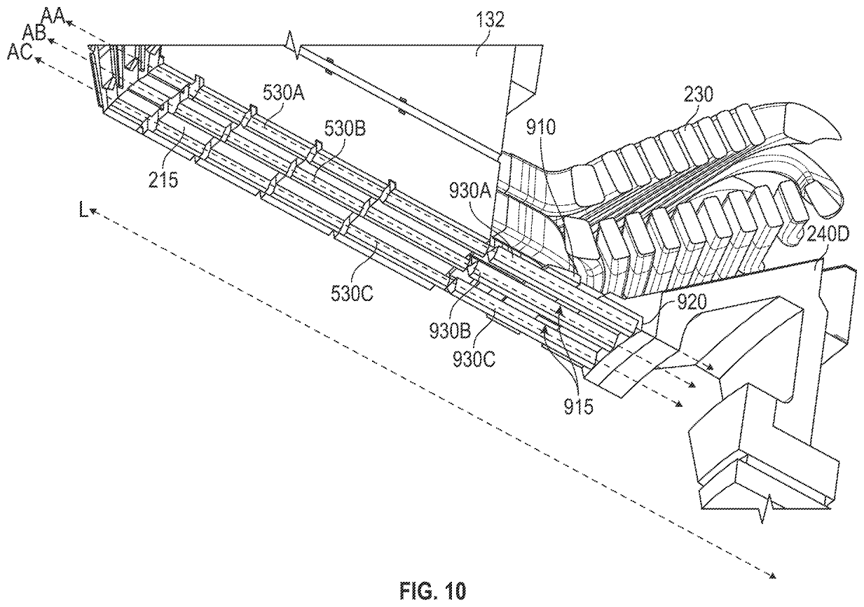

FIG. 10 is a perspective view of portions of the third embodiment of radially inward-facing surface 215 in FIG. 5 and support structure 240D in FIG. 9, according to an embodiment. As illustrated, ribs 530 on radially inward-facing surface 215 align with ribs 930 on support structure 240D, along axial axes that are parallel to longitudinal axis L. For example, rib 530A aligns with rib 930A along axial axis AA, rib 530B aligns with rib 930B along axial axis AB, and rib 530C aligns with rib 930C along axial axis AC. Again, it should be understood that, in reality, radially inward-facing surface 215 and support structure 240D would be annular around longitudinal axis L.

In an alternative embodiment in which ribs 930 are angled in a circumferential direction around longitudinal axis L, ribs 930 may not align with ribs 530, which are parallel to the axial axes. Rather, ribs 930 would be angled with respect to ribs 530. Alternatively, ribs 530 could also be angled in the circumferential direction at the same angle as ribs 930, such that the ribs 530 and 930 align at an angle with respect to the axial axes. In yet another alternative, ribs 530 could be angled in the circumferential direction, while ribs 930 are parallel to the axial axes, such that ribs 930 do not align with ribs 530.

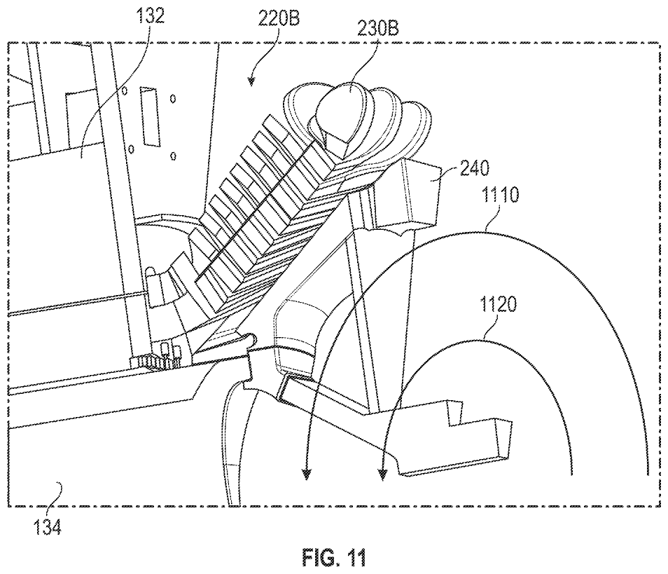

FIG. 11 is a perspective view of a portion of motor 130 in integrated compressor 100, according to a third embodiment. The top coil of end-winding 230 has a spiral orientation 1110. In addition, motor 130 is configured to rotate motor rotor 134 in a rotation direction 1120. In an embodiment, the top coils of end-windings 230A and 230B and/or motor 130 are configured, such that the spiral orientation 1110 of the top coils of end-windings 230A and 230B are the same as the rotation direction 1120 of motor rotor 134. Aligning the spiral orientation 1110 and rotation direction 1120 in this manner reduces the amount of recirculation in end-winding cavity 220 by forcing the fluid toward air gap 210.

### INDUSTRIAL APPLICABILITY

An integrated compressor 100 may comprise a hermetically sealed electric motor 130 that drives a shaft to rotate rotor assemblies within a compression system 140. In particular, motor 130 comprises a motor stator 132 that creates a magnetic field to rotate a motor rotor 134, with an air gap 210 between motor stator 132 and motor rotor 134. Compression system 140 compresses a fluid, supplied via an inlet path 142, and discharges the compressed fluid via an outlet path 148. For example, integrated compressor 100 may be incorporated into a gas pipeline to compress gas (e.g., methane) as the working fluid.

During operation of motor 130, motor 130 experiences windage losses. Windage loss refers to the reduction in efficiency in motor 130 due to flow resistance along air gap 210. In addition, motor 130 experiences radial forces in air gap 210 that can require large bearing sizes and a complicated control system to overcome these radial forces. While a smooth radially inward-facing surface 215 on motor stator 132 may decrease windage losses, it results in high radial load on motor rotor 134. Advantageously, the use of partial grooves 315 or riblets 415 or 515 on radially inward-facing surface 215 provide low to moderate windage losses, relative to a smooth radially inward-facing surface 215, while substantially decreasing the radial load on motor rotor 134, relative to a smooth radially inward-facing surface 215. Partial grooves 315 or riblets 415 or 515 may be sized and/or arranged in any suitable manner for the particular application.

While the features of partial grooves 315 and riblets 415 or 515 have been described as being implemented on a radially inward-facing surface 215 of a motor stator 132, these features may be implemented on any system with an air gap between a stationary and rotating component. For example, similar or identical partial grooves 315 or riblets 415 or 515 may be formed on radially inward-facing surface 128 of RMB stator 122 in radial bearing system 120 and/or radially inward-facing surface 158 of the TMB stator in thrust bearing system 150, in addition to or instead of on radially inward-facing surface 215 of motor stator 132. In general, a system may comprise: a rotor with a longitudinal axis; a stator encircling the rotor and concentric with the longitudinal axis; and an air gap between the stator and the rotor, wherein a radially inward-facing surface of the stator, defining a radially outward boundary of the air gap, comprises a plurality of partial grooves that are recessed into the radially inward-facing surface or a plurality of riblets that protrude from the radially inward-facing surface.

In addition, the inventors have discovered that, during the operation of motor 130, recirculation flows form in end-winding cavities 220. These recirculation flows can recirculate high-temperature fluid from the vicinity of motor rotor 134 to end-winding cavities 220, thereby heating end-windings 230 and/or reducing the cooling of end-windings 230. With reference to the orientation of aft end-winding cavity 220B that is illustrated in FIG. 2, the recirculation flow tends to form in a generally counterclockwise direction from air gap 210, axially outward and radially upward along support structure 240, and axially inward towards end-winding 230B. The various disclosed embodiments of support structure 240, and particularly, nose portions 248A, 248B, 248C, and 248D, disrupt these recirculation flows and, in at least some embodiments, force fluid to flow in reverse of the recirculation flow (e.g., back towards air gap 210). In addition, the alignment of the spiral orientation 1110 of the top coil of each end-winding 230 with the rotation direction 1120 of motor rotor 134 can further reduce these recirculation flows by forcing fluid in end-winding cavity 220 towards air gap 210.

It should be understood that the various features disclosed herein may be implemented individually or in any combination. For example, a radially inward-facing surface 215 having partial grooves 315 or riblets 415 or 515 may be implemented in an embodiment without a support structure 240 having nose portion 248A, 248B, 248C, or 248D, or may be implemented in an embodiment with a support structure 240 having nose portion 248A, 248B, 248C, or 248D. Similarly, support structure 240, having nose portion 248A, 248B, 248C, or 248D, may be implemented in an embodiment without a radially inward-facing surface 215 having partial grooves 315 or riblets 415 or 515, or may be implemented in an embodiment with a radially inward-facing surface 215 having partial grooves 315 or riblets 415 or 515. Furthermore, the alignment of spiral orientation 1110 with rotation direction 1120 may be implemented individually or in combination with any of these embodiments.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented in an integrated compressor, it will be appreciated that it can be implemented in various other types of compressors and machines, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A system comprising:
a rotor with a longitudinal axis;
a stator encircling the rotor and concentric with the longitudinal axis; and
an air gap between the stator and the rotor,
wherein a radially inward-facing surface of the stator, defining a radially outward boundary of the air gap, comprises a plurality of partial grooves that are recessed into the radially inward-facing surface or a plurality of riblets that protrude from the radially inward-facing surface.

2. The system of claim 1, wherein the radially inward-facing surface of the stator comprises the plurality of partial grooves.

3. The system of claim 2, wherein the plurality of partial grooves are arranged in a plurality of circumferential rings around the longitudinal axis, and the plurality of circumferential rings are spaced apart from each other along the longitudinal axis.

4. The system of claim 3, wherein each of the plurality of circumferential rings comprises a plurality of partial grooves that are spaced apart from each other by a circumferential distance.

5. The system of claim 1, wherein the radially inward-facing surface of the stator comprises the plurality of riblets.

6. The system of claim 5, wherein the plurality of riblets are arranged as a plurality of ribs that are each oriented along an axial axis that is parallel to the longitudinal axis, and the plurality of riblets are spaced apart from each other around the longitudinal axis by a circumferential distance.

7. The system of claim 5, wherein the plurality of riblets are arranged in a plurality of circumferential rings around the longitudinal axis, and the plurality of circumferential rings are spaced apart from each other along the longitudinal axis.

8. The system of claim 7, wherein each of the plurality of circumferential rings comprises a plurality of riblets that are spaced apart from each other by a circumferential distance.

9. The system of claim 1, wherein the system is a motor and further comprises:
at least one end-winding extending from an end of the stator into an end-winding cavity; and
a support structure that partially defines the end-winding cavity, wherein the support structure includes a main body with a radially outward end and a radially inward end, and a nose portion extending from the radially inward end.

10. The system of claim 9, wherein the nose portion of the support structure comprises:
a lattice structure that extends in an axial direction; and
and a plurality of ribs that are positioned radially inward from the lattice structure and are longer than the lattice structure in the axial direction, and wherein the plurality of ribs are spaced apart from each other around the longitudinal axis by a circumferential distance.

11. The system of claim 10, wherein the lattice structure comprises:
two parallel rails that are annular around the longitudinal axis; and
a plurality of rungs extending between the two parallel rails, such that spaces are formed between adjacent pairs of the plurality of rungs, wherein the spaces are aligned with spacing between the plurality of ribs.

12. The system of claim 11, wherein a radial thickness of a forward one of the two parallel rails, forming an end of the lattice structure, decreases in the axial direction.

13. The system of claim 9, wherein the nose portion of the support structure comprises a plurality of vanes extending radially outward from a radially outward-facing surface of the nose portion.

14. The system of claim 13, wherein the radially outward-facing surface of the nose portion is curved radially inward from the radially inward end of the main body to a lip that is radially inward from the plurality of vanes.

15. The system of claim 14, wherein the support structure comprises a shroud positioned radially outward from the plurality of vanes and defining a plurality of pockets between the shroud, two adjacent ones of the plurality of vanes, and the nose portion, wherein each of the plurality of pockets is open towards the lip.

16. The system of claim 9, wherein the nose portion comprises a radially outward lip, a radially inward lip, and a curved surface connecting the radially outward lip to the radially inward lip to define a mouth that is open at a radially inward end of the support structure.

17. The system of claim 1, wherein the system is a motor and further comprises at least one end-winding extending from an end of the stator, wherein a spiral orientation of a top coil of the at least one end-winding is aligned with a rotation direction of the rotor.

18. An integrated compressor comprising:
the system of claim 1;
a shaft having the longitudinal axis; and
a plurality of rotor assemblies attached to the shaft.

19. A motor comprising:
a motor rotor with a longitudinal axis;
a motor stator encircling the motor rotor and concentric with the longitudinal axis;
an air gap between the motor stator and the motor rotor;
at least one end-winding extending from an end of the motor stator into an end-winding cavity; and
a support structure that partially defines the end-winding cavity, wherein the support structure includes a main body with a radially outward end and a radially inward end, and a nose portion extending from the radially inward end and configured to disrupt a recirculation flow within the end-winding cavity, wherein the nose portion comprises a plurality of ribs that are each oriented along an axial axis that is parallel to the longitudinal axis, and wherein the plurality of ribs of the nose portion are spaced apart from each other around the longitudinal axis by a circumferential distance,
wherein a radially inward-facing surface of the motor stator, defining a radially outward boundary of the air gap, comprises a plurality of riblets that protrude from the radially inward-facing surface, wherein the plurality of riblets are arranged as a plurality of ribs that are each aligned with the axial axis of a respective one of the plurality of ribs of the nose portion.

20. A motor comprising:
a motor rotor with a longitudinal axis;
a motor stator encircling the motor rotor and concentric with the longitudinal axis;
an air gap between the motor stator and the motor rotor; and
at least one end-winding extending from an end of the motor stator into an end-winding cavity, wherein a spiral orientation of a top coil of the at least one end-winding is aligned with a rotation direction of the motor rotor.
